(19) United States
(12) Patent Application Publication
(10) Pub. No.: US 2020/0269482 A1
(43) Pub. Date: Aug. 27, 2020

(54) INJECTION MOLDING MACHINE

(71) Applicant: TOSHIBA KIKAI KABUSHIKI KAISHA, Tokyo-to (JP)

(72) Inventors: Kentaro SATO, Numazu-shi (JP); Ryo SHIRAKI, Numazu-shi (JP); Jun ENOMOTO, Numazu-shi (JP); Ryoji TOMINAGA, Numazu-shi (JP)

(73) Assignee: TOSHIBA KIKAI KABUSHIKI KAISHA, Tokyo-to (JP)

(21) Appl. No.: 16/841,799

(22) Filed: Apr. 7, 2020

Related U.S. Application Data
(63) Continuation of application No. PCT/JP2018/038901, filed on Oct. 18, 2018.

(30) Foreign Application Priority Data
Oct. 20, 2017 (JP) 2017-203861

(51) Int. Cl. B29C 45/76; B29C 45/00

(52) U.S. Cl. CPC B29C 45/768; B29C 45/0025

(57) ABSTRACT

An injection molding machine includes: a storage configured to store information showing relationships between a plurality of operation processes included in a molding process for the product and a plurality of molding controls related to the operation processes, and information showing relationships between the molding controls and a plurality of molding defects of the product; a display which is configured to display a plurality of the operation processes and the molding defects, and displays the molding controls related to a selected operation process selected from a plurality of the operation processes by an operator and a selected molding defect selected from a plurality of the molding defects by the operator as relevant molding controls; and a controller configured to extract the molding controls as the relevant molding controls, based on a table preset from a plurality of the operation processes and the molding defects.

### BACKGROUND OF THE INVENTION

### Field of the Invention

An embodiment of the present invention relates to an injection molding machine.

### Background Art

An injection molding machine molds a resin by pouring a molten resin into a cavity between molds clamped together. In the injection molding machine, when molding defects occur, an operator needs to select and reset appropriate molding controls or molding conditions to eliminate the molding defects.

### CITATION LIST

### Patent Literature

[Patent Literature 1] Japanese Patent Application Laid-Open No. 2003-099501

### SUMMARY OF THE INVENTION

However, in order to select appropriate molding controls corresponding to molding defects, the operator needs to be familiar with the injection molding machine and the molded product. Even if an unskilled operator who does not grasp the entire molding control resets the molding controls of the injection molding machine, the molding defects may not be prevented.

Therefore, the present invention was made to solve the above-mentioned problem, and an object of the invention is to provide an injection molding machine capable of easily setting injection molding controls to prevent molding defects.

An injection molding machine according to the present embodiment is an injection molding machine for molding a product by injecting a resin into a mold, and includes: a storage configured to store information showing relationships between a plurality of operation processes included in a molding process for the product and a plurality of molding controls related to the operation processes, and information showing relationships between the molding controls and a plurality of molding defects of the product; a display which is configured to display a plurality of the operation processes and the molding defects, and displays the molding controls related to a selected operation process selected from a plurality of the operation processes by an operator and a selected molding defect selected from a plurality of the molding defects by the operator as relevant molding controls; and a controller configured to extract the molding controls as the relevant molding controls, based on a table preset from a plurality of the operation processes and the molding defects.

### BRIEF DESCRIPTION OF THE DRAWINGS

FIG. 1 is a block diagram illustrating a configuration example of an injection molding machine according to a first embodiment;

FIG. 2 is a table showing the relationships among molding controls, operation processes, and molding defects;

FIG. 3 is a table showing molding controls and the corresponding descriptions;

FIG. 4 is a screen of a display displaying relevant molding controls from operation processes and molding defects;

FIG. 5 is a diagram showing a setting screen for “Retraction Control”; and

FIG. 6 is a diagram showing a setting screen for “Measurement Control”.

### DETAILED DESCRIPTION OF THE INVENTION

Hereinafter, embodiments of the present invention will be described with reference to the drawings. The present embodiments do not limit the present invention

The drawings are schematic or conceptual, and the proportions of parts are not necessarily the same as the actual proportions. In the description and the drawings, the same components as those described above with the drawings are labeled by the same reference signs, and the detailed description will omitted as appropriate.

### First Embodiment

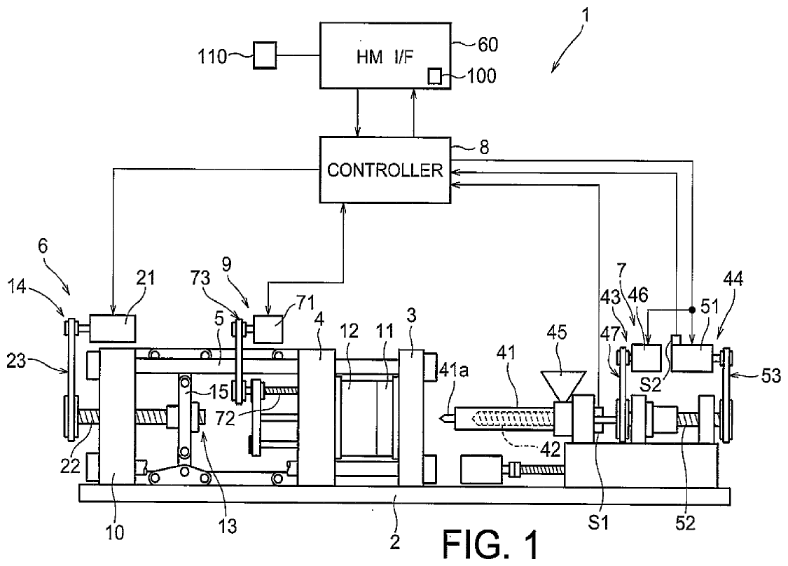

FIG. 1 is a block diagram illustrating a configuration example of an injection molding machine 1 according to the first embodiment. The injection molding machine 1 is a machine capable of repeatedly executing a series of injection molding operations, and, for example, repeats the operation of molding a molded product one time as a cyclic operation. The time of executing a series of cyclic operations is called a cycle time.

The injection molding machine 1 includes a frame 2, a stationary platen 3, a movable platen 4, a tie bar 5, a mold clamping drive mechanism 6, an injection device 7, a controller 8, an ejection mechanism 9, a human-machine interface 60, a storage 110, an injection pressure sensor S1, and a screw position sensor S2.

The frame 2 is a base of the injection molding machine 1. The stationary platen 3 is fixed on the frame 2. A stationary mold 11 as a first mold is attached to the stationary platen 3. One end of the tie bar 5 is fixed to the stationary platen 3, and another end is fixed to a support platen 10. The tie bar 5 extends from the stationary platen 3 via the movable platen 4 to the support platen 10

The movable platen 4 is mounted on a linear guide (not shown) provided on the frame 2.

The movable platen 4 is guided by the tie bar 5 or the linear guide, and can move closer to or away from the stationary platen 3. A movable mold 12 as a second mold is attached to the movable platen 4. The movable mold 12 faces the stationary mold 11, approaches the stationary mold 11 together with the movable platen 4, and is combined with the stationary mold 11. A space corresponding to the shape of a product is formed between the movable mold 12 and the stationary mold 11 by bringing the movable mold 12 and the stationary mold 11 into alignment and contact with each other.

The mold clamping drive mechanism 6 includes a toggle mechanism 13, and a toggle mechanism driver 14. The toggle mechanism driver 14 includes a mold clamping servomotor 21, a ball screw 22 and a transmission mechanism 23 to drive the toggle mechanism 13. A cross-head 15 is attached to the tip of the ball screw 22. As the ball screw 22 rotates, the cross-head 15 approaches the movable platen 4 or moves away from the movable platen 4. The transmission mechanism 23 transmits a rotation of the mold clamping servomotor 21 to the ball screw 22 to move the cross-head 15.

When the toggle mechanism driver 14 moves the cross-head 15, the toggle mechanism 13 is actuated. For example, when the cross-head 15 moves toward the movable platen 4, the movable platen 4 moves toward the stationary platen 3, and clamping of the molds 11, 12 is performed. Conversely, when the cross-head 15 moves in a direction away from the movable platen 4, the movable platen 4 moves in a direction away from the stationary platen 3, and mold opening of the molds 11, 12 is performed.

The ejection mechanism 9 includes an ejection servomotor 71, a ball screw 72 and a transmission mechanism 73 to remove a molded product from the movable mold 12. A tip of the ball screw 72 penetrates an inner surface of the movable mold 12. As the ball screw 72 rotates, the ball screw 72 pushes out the product adhering to the inner surface of the movable mold 12. The transmission mechanism 73 transmits a rotation of the ejection servomotor 71 to the ball screw 72 and moves the ball screw 72 in a left-right direction of FIG. 1.

The injection device 7 includes a heated barrel (band heater) 41, a screw 42, a measurement driver 43, and an injection driver 44. The heated barrel 41 includes a nozzle 41a for injecting a molten resin into the cavity of the clamped molds. The heated barrel 41 stores the resin from a hopper 45 while heating and melting the resin, and injects the molten resin from the nozzle 41a. The screw 42 is movable while rotating or without rotating in the heated barrel 41. In a measurement process, the screw 42 rotates, and an injection amount of the molten resin injected from the barrel 41 is measured and determined by the rotation amount (moved distance) of the screw 42. In the injection process, the screw 42 moves without rotating, and injects the molten resin from the nozzle 41a.

The measurement driver 43 has a measurement servomotor 46, and a transmission mechanism 47 for transmitting a rotation of the measurement servomotor 46 to the screw 42. When the measurement servomotor 46 is driven and the screw 42 is rotated in the heated barrel 41, the resin is introduced into the heated barrel 41 from the hopper 45. The introduced resin is fed to the tip side of the heated barrel 41 while being heated and kneaded. The resin is melted and stored in a tip portion of the heated barrel 41. The molten resin is injected from the barrel 41 by moving the screw 42 in a direction opposite to the direction at the time of measurement. At this time, the screw 42 moves without rotating and pushes the molten resin out through the nozzle. In the present embodiment, the molten resin is used as a molding material, but the molding material is not limited to the molten resin and may be metal, glass, rubber, a carbonized compound including carbon fiber, or the like.

The injection driver 44 includes an injection servomotor 51, a ball screw 52, and a transmission mechanism 53. As the ball screw 52 rotates, the screw 42 moves in the left-right direction of FIG. 1 in the heated barrel 41. The transmission mechanism 53 transmits a rotation of the injection servomotor 51 to the ball screw 52. Thus, as the injection servomotor 51 rotates, the screw 42 moves. By pushing the molten resin stored in the tip portion of the heated barrel 41 out through the nozzle 41a by the screw 42, the molten resin is injected from the nozzle 41a.

The injection pressure sensor S1 detects a filling pressure when filling the molten resin into the mold from the barrel 41, and a hold pressure in a pressure holding process. In the injection process, the injection pressure sensor S1 detects an injection pressure of injecting the molten resin from the barrel 41 into the mold. In the pressure holding process, the injection pressure sensor S1 detects a hold pressure of the molten resin after changing the hold pressure from speed control to pressure control.

The screw position sensor S2 detects the position of the screw 42. Since the screw 42 moves with the rotation of the injection servomotor 51, the screw position sensor S2 may detect the position of the screw 42 from the rotational speed and the angular position of the injection servomotor 51. By detecting the position of the screw 42 at predetermined control cycles, the velocity and acceleration of the screw 42 can be found.

The human-machine interface (HM I/F) 60 displays various pieces of information related to the injection molding machine 1. The HM I/F 60 may include, for example, a display and a keyboard, or may be a touch-panel display. A user can input settings, such as instructions concerning operations of the injection molding machine 1, through the HM I/F 60. For example, operation processes of injection molding include a filling process of injecting a molten resin into a mold, a switching process of switching from the filling process to a pressure holding process, the pressure holding process of controlling the pressure of the molten resin in the cavity of the mold, and a measurement process of measuring the resin which is filled into the cavity. The operator inputs various settings related to the operation processes of injection molding through the HM I/F 60. The injection molding machine 1 molds a product according to the operation processes.

The controller 8 monitors sensor information received from various sensors (not shown) during the injection process, and controls the injection device 7 based on the sensor information. Moreover, the controller 8 controls the screw 42 in accordance with the setting value set through the HM I/F 60. Furthermore, the controller 8 displays necessary data on the display 100.

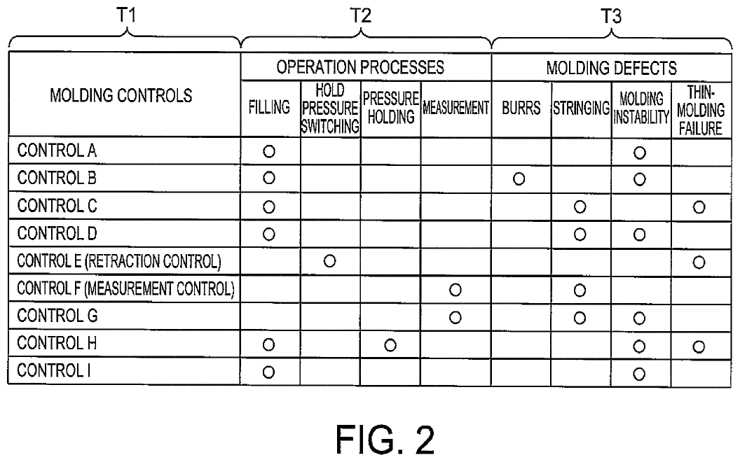

The storage 110 stores information showing the relationships between a plurality of operation processes included in a product molding process and a plurality of molding controls related to the operation processes. The storage 110 also stores information showing the relationships between molding controls and a plurality of molding defects of the product. FIG. 2 is a table showing the relationships among molding controls, operation processes, and molding defects. The molding controls are displayed in Table T1, the operation processes are displayed in Table T2, and the molding defects are displayed in Table T3.

Here, the molding controls in Table T1 are controls of parameters which are set to predetermined values in a normal injection molding operation, and are controls of accompanying special parameters. Therefore, in the normal operation, the settings of such special parameters are not changed. When a molding defect occurs, the settings of these parameters may be changed to prevent the molding defect. The parameters may be, for example, a retraction control for retracting the screw 42 by a predetermined distance after filling the resin, or a measurement control for gradually reducing the speed of the screw 42 in the measurement process. Although these parameters are set to predetermined values in the normal injection molding operation, changing the parameters may lead to prevention of molding defects. In table T1, Control A to Control I are displayed as molding controls. For example, Control E is the retraction control, and Control F is the measurement control.

The operation processes shown in Table T2 include, for example, the filling process, the hold pressure switching process, the pressure holding process, and the measurement process.

The molding defects shown in Table T3 include, for example, burrs formed on the product, leakage of resin from the tip of the nozzle 41a, and abnormalities in the shape or thickness of the product. The leakage of resin from the nozzle 41a causes “stringing” of the resin that stretches like a thread from the tip of the nozzle 41a. Abnormalities in the shape or thickness of the product cause “molding instability” representing variations in the shape of the product, or a “thin-molding failure” in which the thickness of the thin product becomes thick.

The molding controls in table T1 are related to the operation processes in table T2 and the molding defects in table T3. In FIG. 2, circles indicate operation processes and molding defects related to molding controls. For example, the retraction control of Control E is related to the hold pressure switching process among the operation processes, and to “thin-molding failure” among the molding defects. The measurement control of Control F is related to the measurement process among the operation processes, and is related to “stringing” among the molding defects. Such relationships among Tables T1 to T3 are stored in the storage 110 in advance. The storage 110 just needs to store Tables T1 to T3, and does not need to accumulate past defects and a vast amount of relevant data as a database.

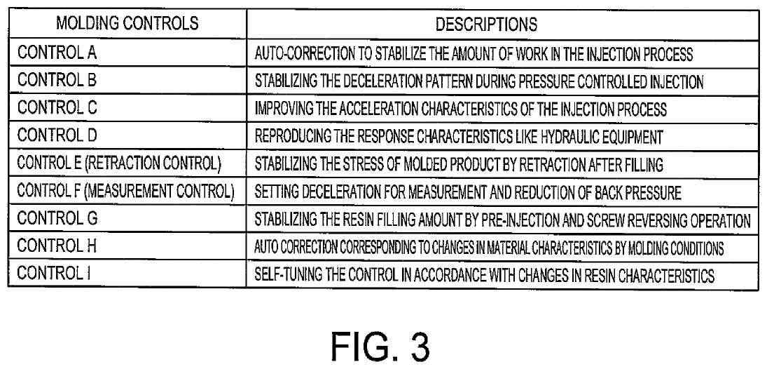

In addition, the storage 110 stores the molding controls and the corresponding descriptions in association with each other. The descriptions are explanations indicating the effects or influence on the operation processes or the molding controls when the settings of the molding controls are changed. FIG. 3 is a table showing the molding controls and the corresponding descriptions. In this table, molding controls A to I and the corresponding descriptions are shown.

For example, the adjustment of Control E (Retraction Control) represents stabilizing the stress of the molded product by retracting the screw 42 after filling. Control F (Measurement Control) represents settings of deceleration of the screw 42 and reduction of pressure (back pressure) applied to the resin in the barrel 41 in the measurement process. Thus, the operator can grasp the outline of the molding controls by referring to the descriptions. Such relationships between the molding controls and the descriptions are stored in the storage 110 in advance.

The injection molding machine 1 having such a configuration extracts a molding control related to a molding defect and enables the operator to change the settings as follows.

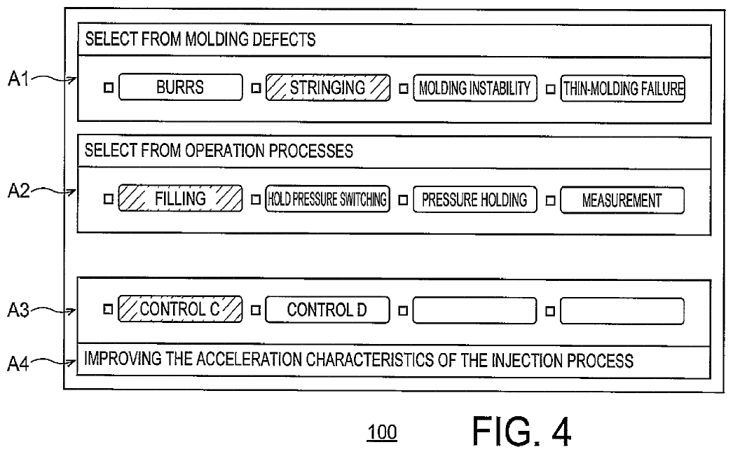

First, when a molding defect occurs, the operator manipulates the HM I/F 60 to display a molding control selection screen on the display 100 as shown in FIG. 4. The display 100 displays a plurality of operation processes and a plurality of molding defects. The display 100 displays a molding control related to a selected operation process selected from the plurality of operation processes by the operator and a selected molding defect selected from the plurality of molding defects by the operator as “relevant molding controls”. For example, FIG. 4 is a screen of the display 100 displaying the relevant molding controls from the operation processes and the molding defects.

An area A1 in the display 100 displays a plurality of molding defects. The operator selects a defect that occurred in the injection molding machine 1 from the area A1. The operator may touch an item of molding defects displayed on the display 100 or may move a pointer displayed on the display 100 onto an item of molding defects, and click or double-click the item. For example, the operator selects “Stringing” as the molding defect. The molding defect selected by the operator will be hereinafter referred to as the “selected molding defect”. In addition, the operator selects an operation process in which the defect occurred from an area A2. For example, the operator selects “Filling process” as the operation process. The operation process selected by the operator will be hereinafter referred to as the “selected operation process”.

When the selected operation process and the selected molding defect are set, the controller 8 refers to Tables T1 to T3 shown in FIG. 2, extracts molding controls related to the selected operation process and the selected molding defect, and displays the extracted molding controls in an area A3 of the display 100. The molding controls related to the selected operation process and the selected molding defect will be hereinafter referred to as the “relevant molding controls”. In FIG. 4, for example, Controls C and D are displayed in the area A3 as the relevant molding controls corresponding to the selected molding defect “Stringing” occurred in the selected operation process “Filling process”. That is, the controller 8 selects molding controls C, D related to the “Filling process” and “Stringing” as the relevant molding controls. In other words, the controller 8 uses the logical conjunction of the molding control related to the selected operation process and the molding control related to the selected molding defect as the relevant molding control. It should be noted that there may be one or more relevant molding controls. In this case, one or more relevant molding controls are displayed in the area A3. Also, there may be no corresponding relevant molding control. In this case, no relevant molding control is displayed in the area A3. Or an error is displayed.

In the case where a plurality of relevant molding controls are displayed in the area A3, the operator selects a molding control that needs to be changed in settings from the relevant molding controls. The relevant molding control selected at this time will be hereinafter referred to as the “selected molding control”. Upon selection of a selected molding control, the controller 8 refers to the table shown in FIG. 3, and displays the description corresponding to the selected molding control in an area A4 of the display 100. When only one selected molding control is displayed in the area A3, the controller 8 may display the description corresponding to the selected molding control in the area A4 of the display 100 without a selecting operation by the operator. Alternatively, when the operator moves the cursor onto an item of relevant molding controls, or when the operator touches an item of relevant molding controls, the controller 8 may display the description in the area A4 of the display 100. By displaying the description corresponding to the relevant molding control, the operator can grasp the effect or influence of the molding control to some degree.

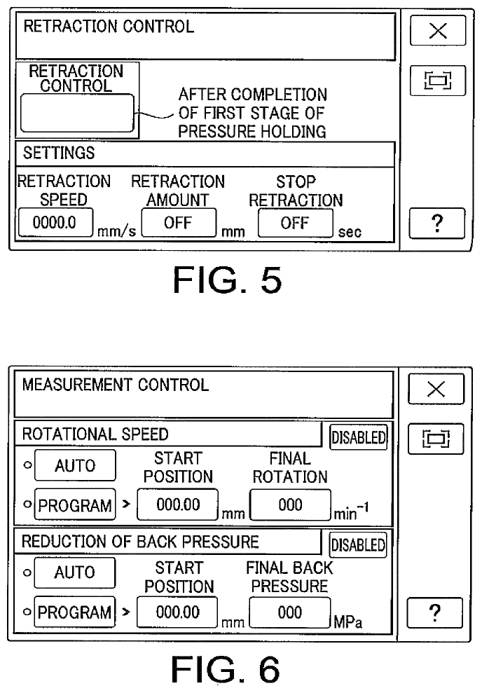

When the operator further selects a relevant molding control, the display 100 subsequently displays a setting screen (pop-up window) for the selected molding control. For example, FIG. 5 is a diagram showing a setting screen for “Retraction Control”. When the operator selects “Retraction Control”, the setting screen shown in FIG. 5 is displayed. The operator sets parameters related to retraction control on this setting screen. For example, the operator can set a time for retracting the nozzle 41a, a retraction speed, a retraction amount, etc.

FIG. 6 is a diagram showing a setting screen for “Measurement Control”. When the operator selects “Measurement Control”, the setting screen shown in FIG. 6 is displayed. The operator sets parameters related to measurement control on this setting screen. For example, the operator sets a reduction of the speed of the screw 42, or sets a back pressure of the resin in the barrel 41. When the operator inputs the settings for the relevant molding control or the selected molding control, the controller 8 changes the settings for the molding control according to the input by the operator. It should be noted that a plurality of selected molding controls may be selected. By combining a plurality of molding controls, molding defects can be more effectively prevented.

As described above, the injection molding machine 1 according to the present embodiment displays the relevant molding controls corresponding to a molding defect and an operation process in which the molding defect occurred. Hence, the operator can readily select a molding control for preventing the molding defect, and can easily change the settings for the molding control. In addition, the injection molding machine 1 displays the descriptions of the relevant molding controls or the selected molding control. Thus, the operator can easily grasp the effects and influence when the settings for the relevant molding controls or the selected molding control are changed. As a result, the operator can select a molding control relevant for preventing a molding defect and can promptly prevent the defect of the product regardless of the level of proficiency with regard to the injection molding machine 1. Furthermore, according to the present invention, it is not necessary to accumulate past defects and a vast amount of relevant data into a database.

While some embodiments of the present invention have been described, these embodiments are presented as examples and are not intended to limit the scope of the invention. These embodiments can be implemented in various other forms, and various omissions, substitutions and modifications can be made without departing from the gist of the invention. Similarly to being included within the scope and the gist of the invention, these embodiments and modifications thereof are included within the scope of the invention described in the claims and equivalents thereof.

1. An injection molding machine for molding a product by injecting a resin into a mold, the injection molding machine comprising:
a storage configured to store information showing relationships between a plurality of operation processes included in a molding process for the product and a plurality of molding controls related to the operation processes, and information showing relationships between the molding controls and a plurality of molding defects of the product;
a display which is configured to display a plurality of the operation processes and the molding defects, and displays the molding controls related to a selected operation process selected from a plurality of the operation processes by an operator and a selected molding defect selected from a plurality of the molding defects by the operator as relevant molding controls; and
a controller configured to extract the molding controls as the relevant molding controls, based on a table preset from a plurality of the operation processes and the molding defects.

2. The injection molding machine according to claim 1, wherein the display displays a setting screen for a selected molding control selected from the relevant molding controls by the operator.

3. The injection molding machine according to claim 1, further comprising a controller configured to extract a molding control related to the selected operation process and related to the selected molding defect as the relevant molding control.

4. The injection molding machine according to claim 1, wherein the display displays a description indicating an effect or influence of a selected molding control selected from the relevant molding controls by the operator, or of the relevant molding control, on the operation process or the molding control.

5. The injection molding machine according to claim 3, wherein when the operator inputs settings for a selected molding control selected from the relevant molding controls by the operator, or for the relevant molding control, the controller changes the settings for the selected molding control or the relevant molding control according to the input by the operator.

6. The injection molding machine according to claim 2, further comprising a controller configured to extract a molding control related to the selected operation process and related to the selected molding defect as the relevant molding control.

7. The injection molding machine according to claim 6, wherein the display displays a description indicating an effect or influence of a selected molding control selected from the relevant molding controls by the operator, or of the relevant molding control, on the operation process or the molding control.

8. The injection molding machine according to claim 6, wherein when the operator inputs settings for a selected molding control selected from the relevant molding controls by the operator, or for the relevant molding control, the controller changes the settings for the selected molding control or the relevant molding control according to the input by the operator.

9. The injection molding machine according to claim 2, wherein the display displays a description indicating an effect or influence of a selected molding control selected from the relevant molding controls by the operator, or of the relevant molding control, on the operation process or the molding control.

10. The injection molding machine according to claim 3, wherein the display displays a description indicating an effect or influence of a selected molding control selected from the relevant molding controls by the operator, or of the relevant molding control, on the operation process or the molding control.
